(19) United States
(12) Patent Application Publication
(10) Pub. No.: US 2002/0154755 A1
(43) Pub. Date: Oct. 24, 2002

(54) Communication method and system including internal and external application-programming interfaces

(75) Inventor: Christophe Gourraud, Montreal (CA)

Correspondence Address: Ericsson Canada Inc, LMC IP IPR Section, 8400 Decarie Blvd, Montreal, QC, H4P 2N2, CA

(73) Assignee: TELEFONAKTIEBOLAGET L M ERICSSON

(21) Appl. No.: 09/841,319

(22) Filed: Apr. 23, 2001

(51) Int. Cl. H04M 7/00

(52) U.S. Cl. 379/219

(57) ABSTRACT

A multi-level application-programming-interface-based system and method permit applications developed by third-party service providers outside a telecommunications network to access capabilities of the network. The applications access a physical gateway using an external-service application-programming-interface. The physical gateway communicates with the network via an internal-service application-programming interface. Internal-service applications resident on the physical gateway utilize internal-service application-programming interfaces to communicate with network entities of the network. The network entities preferably each comprise a logical gateway that is used to communication via the internal-service application-programming interface with the internal-service applications.

### RELATED APPLICATIONS

This patent application is related by subject matter to a U.S. Patent Application entitled “APPLICATION-PROGRAMMING-INTERFACE-BASED METHOD AND SYSTEM INCLUDING TRIGGERS” and bearing Attorney Docket No. 27950-432USPT, which is being filed on the same date as this patent application and is incorporated by reference.

### BACKGROUND

In connection with phenomenal growth in popularity of the Internet, there has been a tremendous interest in use of packet-switched network infrastructures (e.g., Internet Protocol (IP) based networks) as a replacement for, or as an adjunct to, existing circuit-switched network infrastructures that are used in today's telephony. From a network operator's perspective, traffic aggregation that is inherent in packet-switched infrastructures allows for a reduction in costs of transmission and infrastructure cost per end user. Such cost reductions ultimately enable the network operator to pass on the concomitant cost savings to end users.

Packet-switched technologies also allow a network operator to offer new services not available via circuit-switched technologies. Existing circuit-switched technologies, such as, for example, Intelligent Networking (IN), Advanced Intelligent Networking (AIN), Wireless Intelligent Networking (WIN), and Customized Application of Mobile Enhanced Logic (CAMEL) have been used mainly for voice telephony and are viewed as having relatively limited functionality compared to packet-switched, IP-based networks. Therefore, these circuit-switched technologies are expected to be phased out over time in favor of packet-switched technologies.

As is well known in the telecommunications industry, services and service provisioning are a major reason for the existence of telecommunications' networks. Services are typically categorized into: (1) basic services (i.e., services that allow basic call processes such as call establishment and termination); and (2) Advanced services, such as multi-media and data services. It is also well known that Advanced services operate as factors for market differentiation and are crucial for the success of a network operator and a service provider.

IP multimedia (IPMM) is an example of an Advanced service. IPMM is an IP-based service that provides synchronized data streams between end points via the Internet. IPMM allows provisioning of integrated voice, data, video, traditional call conferencing, call control supplementary measures, multimedia transport, and mobility, as well as services that integrate web, email, presence and instant messaging applications with telephony.

The emergence of packet-switched technologies has resulted in the potential for convergence among disparate technologies such as circuit-switched telecommunication networks (e.g., cellular networks), Advanced information technology (e.g., Application Programming Interfaces (APIs) and Common Object Request Broker Architecture (CORBA)), and Internet-based technologies (e.g., hypertext transfer protocol, hypertext mark-up language/eXtensible mark-up language, and Java servlets). However, there is particular concern regarding how the different technologies will interact with one another.

One approach to integrating these disparate technologies is known as Parlay. Parlay is a set of object-oriented APIs that have been developed by an industry consortium of telecommunications companies and information technology companies known as the Parlay Group. It is hoped that Parlay will permit a combination of IP-based application development resources with the extensive capabilities of telecommunications networks. One of Parlay's objectives is to facilitate development of API-based applications across wireless networks, IP-based networks, and circuit-switched networks such as the Public Switched Telephone Network (PSTN). The Parlay APIs have been developed to provide a common open interface into various types of telecommunications networks and to promote interworking of packet-switched networks and circuit-switched networks. Parlay aims to permit controlled access to various kinds of telecommunications networks in order to permit creation of a wide range of new services, such as, for example, IPMM applications.

The Parlay APIs are designed to permit network operators to allow controlled access to network resources by parties outside the network, who are referred to as third-party service providers. Third-party service providers are typically information technology companies that do not have intimate knowledge of telecommunications or the operation of telecommunications networks. Applications outside a telecommunications network can use the Parlay APIs to access and direct network resources to perform specific actions or functions.

This type of access was previously available only to telecommunications network operators. Therefore, any time a new service was to be implemented, detailed technical and operational involvement of the network operators themselves was necessitated. In contrast, the Parlay APIs aim to allow new services, including third-party applications, to be developed without requiring intimate knowledge of the internal operation of the telecommunications networks on the part of the third-party service providers.

While one of the goals of the Parlay Group is to enable a new generation of off-the-shelf network applications and components to be developed by third-party service providers independently of the underlying networks, the complexity of the Parlay APIs renders them, in actuality, better suited for applications developed by telecommunications companies as opposed to third-party service providers. Parlay reuses many IN concepts, because it was initially defined by telecommunications companies. For example, the Parlay APIs currently require third-party service providers to be familiar with the IN call model and to understand operation of IN detection points. Many third-party service providers have been hesitant to develop Parlay applications due to their lack of familiarity with telecommunications networks and protocols.

Open Service Access (OSA), a version of Parlay developed by the Third Generation Partnership Project (3GPP), was introduced in the Universal Mobile Telecommunications System (UMTS) standardization. OSA is part of the Virtual Home Environment (VHE) and is often referred to as Parlay/OSA. Parlay/OSA was developed to be utilized in CAMEL-compatible wireless networks. Java APIs for Integrated Networks (JAIN) are application programming interfaces that are currently a competitor of Parlay. Efforts are ongoing to make Parlay and JAIN compatible with one another.

Parlay/OSA can be used as a complement to IN-based systems, such as, for example, CAMEL in Global System for Mobile communications (GSM) networks. Parlay/OSA is not currently used in GSM for the full scope of Advanced services and relies in part on CAMEL-implemented mechanisms. However, because movement is taking place towards providing Advanced services such as IPMM, Parlay/OSA might in the future completely support Advanced service provisioning independently of CAMEL or other IN-based support.

Parlay (including Parlay/OSA) as currently defined has several drawbacks. The Parlay APIs are too complex for many third-party service providers, which complexity requires that the third-party service providers have intimate knowledge of the details of operation of telecommunications networks on which they want to deploy their applications. For example, the Parlay APIs as currently defined require that applications handle both service management and service execution issues. It would be preferable to unburden the third-party service providers with responsibility for service management issues and to let the telecommunications networks handle these duties.

In addition, Parlay is not well-adapted to subscription-based services (e.g., API-based interactions versus separate management tools). Therefore, each time a new user wants to subscribe to a service, an API is invoked, which is unduly cumbersome. Parlay is also not well suited to VHE service subscription, in which users subscribe with a home environment rather than with a third-party service provider. Moreover, too much control over the network is given to third-party service providers in the current implementation of Parlay, which is of concern to network operators and runs counter to the stated objectives of Parlay, in which third-party service provider applications are intended to be agnostic with respect to the details, such as the topology, of the network.

Parlay also fails to optimally support underlying technology independence. For example, if a given IN detection point does not exist in a particular version of IN (e.g., CAMEL), that version of IN and Parlay must be matched to account for this fact. This matching requirement gives third-party service providers too much information about and control over the network.

Even though a migration to packet-switched networks is ongoing, many network operators want to keep IN as their preferred solution for implementation of voice services in order to avoid incurring costs associated with a wholesale change from circuit-switched networks (e.g., IN-based networks) to packet-switched networks (e.g., IP-based networks). These operators are reluctant to invest in Parlay-based solutions, despite Parlay's enhanced functionality relative to IN. It would therefore be desirable if IN-based solutions were integrated with Parlay-based solutions so that a more gradual migration could take place. While Parlay/OSA is preferably the primary solution for Advanced services, it would be advantageous for optimal Advanced-service (e.g., IPMM) support to not be jeopardized by Parlay's support of IN. In contrast, other operators want to use Parlay for both voice and also for Advanced services to the exclusion of IN. For these operators, Parlay must be able to provide all of the functionality of IN as well as the Advanced services of packet-based networks.

Parlay/OSA as currently defined does not equal current IN capabilities, in large part due to its lack of triggers. As noted above, a gradual migration from IN to Parlay/OSA will be severely hindered if Parlay/OSA is not able to equal current IN capabilities.

Another drawback of Parlay is its failure to support service interaction. The term service interaction refers generally to inter-operation of multiple applications. An example of service interaction would be if a mobile station user had subscribed to a call forwarding service and to a call barring service. In this example, the call barring service, which is resident on a first application, bars incoming calls from telephone numbers pre-selected by the mobile station user. The call forwarding service, which is resident on a second application, forwards incoming calls toward the mobile station to another telephone number selected by the user. If service interaction is not supported, a situation could be envisioned in which the two applications would not work together as the user would want.

It would be expected that the user would not want to forward barred calls since barred calls are by definition calls that the user does not want to receive. Therefore, it would be desirable for incoming calls to be screened first to determine whether they are barred and then forwarded only if they have not been pre-selected by the user to be so barred.

Parlay's lack of support of service interaction prevents two or more applications from subscribing to the same notification. A notification serves as notice to an application that a given event has occurred on the network. Therefore, in the example above, once either the call barring application or the call forwarding application has subscribed to a given notification, the other application cannot also subscribe to that notification.

Service interaction is not supported by Parlay because, in Parlay, applications directly access detection points rather than a detection point leading to triggers that then lead to the applications, as in IN. Therefore, unlike IN, in which a single detection point can correspond to several triggers and a single trigger can correspond to several applications, there is, in Parlay, a one-to-one correspondence between an application and a detection point. Because there are no triggers in Parlay, when applications seize a detection point, all other applications are prohibited from seizing the same detection point.

In the above example, it was assumed that two different applications handled the call barring and call forwarding services, respectively. One solution to the service interaction problem could be to place both applications within the same third-party-service-provider-developed application. However, this requirement runs counter to one of the stated goals of Parlay, which is to provide flexibility to third-party service providers to develop relatively simple applications. It also requires third-party service providers to know more about the intimate details of the networks' operations than is optimal.

Management of service interaction and execution of a service by an application require the application to be unduly complex. In other words, the application is required not only to implement the service but also to implement setting of conditions under which the service should be invoked. It would be preferable if the network were able to handle service interaction issues and invoke applications as needed. With network-handled service interaction, the application would only know that it has been invoked and would not be aware of conditions on the network that resulted in its invocation.

Another possibility to fix the call barring/call forwarding problem discussed above would be to allow the network to cheat by not providing to the call forwarding application a particular notification relevant to call forwarding to which it has subscribed if the network determines that call barring is applicable to the number of the incoming call. Such network cheating would ensure that call forwarding is not invoked. However, if the network is allowed to cheat in this manner, the freedom supposedly given to the application is artificial because the application's request to be notified is not being fulfilled. If network cheating is implemented as a solution to the service interaction problem, the network operator must know a great deal about the application. This is obviously not ideal, given Parlay's goal of allowing third-party service provider applications to be implemented on the network without the network operator being intimately involved in operation of the applications.

In Parlay and OSA, gateways are used to permit third-party applications to have access to the capabilities of networks. These gateways can be either physical or logical, as described in more detail below. In Parlay, no mention of physical versus logical gateways is made. OSA states that either logical or physical gateways can be used. It appears to be a matter of choice; however, it is not really a choice, but rather depends upon how the APIs are defined.

Referring now to the FIGURES, FIG. 1 is a block diagram illustrating an exemplary architecture 100 that includes a physical gateway 104 between a third-party domain 102 and public telecommunication network domains 106. The architecture 100 includes the third-party domain 102, a physical gateway 104, and the public network domains 106. The public network domains 106 comprise a plurality of network entities NE₁-NEₙ. The physical gateway 104 serves to provide open, non-discriminatory, and secure access to functionality of the public network domains 106. The public network domains 106 can include, for example, the Public Land Mobile Network (PLMN), Public Switched Telephone Network (PSTN), as well as Internet Protocol (IP) based networks. The physical gateway 104 provides a connection between the third-party domain 102 and the public network domains 106, including the network entities NE₁-NEₙ.

The physical gateway 104 is a specialized network entity that supports an application-programming interface, such as Parlay/OSA, and communicates with at least one network entity of the plurality of network entities NE₁-NEₙ that supports capabilities to be accessed by third-party applications resident on the third-party domain 102. Thus, a third-party application on the third-party domain 102 communicates with the physical gateway 104 via APIs 108 and the physical gateway 104 communicates via an interface 110 with at least one network entity of the plurality of entities NE₁- NEₙ. in the public network domains 106 in order to access capabilities of the network domains 106.

Neither Parlay nor OSA addresses what type of API or protocol should be used on the interface 110 for communications between the physical gateway 104 and the public network domains 106. Therefore, an intermediate application-programming interface or protocol on the interface 110 must be developed in order for communication between the physical gateway 104 and the public network domains 106 to occur.

The intermediate protocol or API on the interface 110 developed to permit the gateway 104 to communicate with the public network domains 106 prevents capabilities of the network entities NE₁-NEₙ from being directly reflected on the application-programming interface 108 and possibly limits performance of the architecture 100 due to the use of mapping/translation. Another drawback of the physical gateway 104 is that, because two interfaces (i.e., the APIs 108 and the API or protocol on the interface 110) must be standardized, standardization is likely to be slower. In addition, it is very likely that the use of the intermediate protocol or API on the interface 110 can create a bottleneck in service between the gateway 104 and the public network domains 106.

It can thus be seen from FIG. 1 that the use of a physical gateway has several drawbacks associated with the necessity of a protocol or interface between the physical gateway and the public network domains to support the application-programming interface between the third-party domain and the gateway.

Referring again to the FIGURES, reference is now made to FIG. 2, wherein there is shown a block diagram illustrating an exemplary architecture including a logical gateway. An architecture 200 includes the third-party domain 102 and the public network domains 106. The domain 102 includes an application server 206 and an application server 208. The domains 106 include a call server 210, shown herein as a serving Call Service Control Function (CSCF), a logical gateway 212, a mobile station 214, and a user profile database 216. The gateway 212 is co-located with the call server 210 and is for that reason referred to as a logical gateway.

A logical gateway is defined herein as a gateway that is co-located with a network entity of the domains 106. In contrast with the physical gateway 104 of FIG. 1, because the gateway 212 is co-located with the call server 210, the gateway 212 does not need to use an intermediate API or protocol on the interface 110 to communicate with the call server 210. The gateway 212 communicates with the application server 208 via the application-programming interface 108 which can be, for example, Parlay or Parlay/OSA. In addition, the call server 210 communicates with the application server 206 via a networking protocol 220, such as, for example, CAMEL.

In FIG. 2, the application server 206 operates according to the networking protocol 220, which can be, for example, IN, WIN, or CAMEL. In contrast, the application server 208 operates according to the API 108, which can be, for example, Parlay, Parlay/OSA, or JAIN. Therefore, the gateway 212 can communicate with the application server 208 when applications utilizing the API 108 need to access the domains 106 and then can communicate directly with the call server 210 without a need for an intermediate API or protocol on the interface 110. The call server 210 communicates with the mobile station 214 via an interface Gm 222.

An advantage of the logical gateway 212 is that capabilities of the domains 106 can be directly reflected in the API 108 without any possibly limiting intermediate APIs or protocols, such as, for example, on the interface 110. In addition, in contrast to the physical gateway 104, faster standardization is possible because there is only one interface to standardize (i.e., the APIs 108). In addition, in contrast to the physical gateway 104, there is no potential bottleneck arising from the need for an additional protocol or API on the interface 110 between the gateway 212 and the call server 210.

Despite the advantages of the logical gateway 212, there are also disadvantages. In Parlay/OSA, if APIs, such as the APIs 108, correspond to capabilities that are supported by entities other than the entity with which the logical gateway 212 is co-located (i.e., the call server 210), it is impossible for the gateway 212 to be purely logical. This is because, if the APIs 108 desire to access capabilities on more than one network entity (e.g., network entities other than the call server 210), the network entity with which the gateway 212 is co-located would be required to communicate with these other network entities. Once a need arises for such communication between, for example, the call server 210 and the other network entity, such as, for example, the user profile database 216, the gateway 212 becomes, in effect, at least partially a physical gateway, because an intermediate API or protocol between the call server 210 and the user profile database 216 is needed. Therefore, the gateway 212 can be completely logical only if all of the capabilities sought by applications such as, for example, those residing on the application server 208 are supported by a single network entity with which the gateway is co-located.

Therefore, it can be seen from FIGS. 1 and 2 that, even though Parlay does not address the issue of a logical versus a physical gateway and OSA states that either a logical or a physical gateway is possible, the choice of a physical or logical gateway is not really a free choice. Thus, it can be seen that although logical gateways have advantages, such as the elimination of a need for an intermediate protocol, if an application needs to access capabilities from more than one network entity, a purely logical gateway is not possible. Physical gateways similarly have disadvantages.

There is accordingly a need for a method and system for enhanced-application-programming interface operation that solves some of the problems associated with the prior art. In particular, there is a need for a solution of the problems associated with the complexity of the Parlay/OSA APIs and the problems associated with the physical and logical gateways.

### SUMMARY

The drawbacks of the prior art are overcome by the present invention, wherein a method of providing telecommunications services includes the steps of an external-service application communicating with a gateway via an external-service-application-programming interface (API) and the gateway invoking at least one internal-service application. The external-service API is adapted to permit the external-service application to communicate with a plurality of entities of the network and the at least one internal-service application communicates with at least one entity of the plurality of entities via an internal-service API. The internal-service API is supported directly by the at least one entity of the plurality of entities.

A telecommunications system includes a gateway adapted to communicate via an external-service API with entities external to a telecommunications network and via an internal-service API with a plurality of entities of the network and at least one network entity adapted to communicate with the gateway. The internal-service API is supported directly by the at least one network entity. The direct support obviates a need for a protocol between the gateway and the at least one entity.

A telecommunications gateway includes means for communicating via an external-service API with at least one entity external to a telecommunications network and means for communicating via an internal-service API with a plurality of entities of the network. The at least one entity external to the network is agnostic with respect to topology of the network. The plurality of entities of the network directly support the internal-service API.

### BRIEF DESCRIPTION OF THE DRAWINGS

A more complete understanding of the present invention can be had by reference to the following Description when taken in conjunction with the accompanying Drawings, wherein:

FIG. 1, previously described, illustrates a block diagram of an exemplary architecture that includes a physical gateway between a third-party domain and public telecommunication network domains;

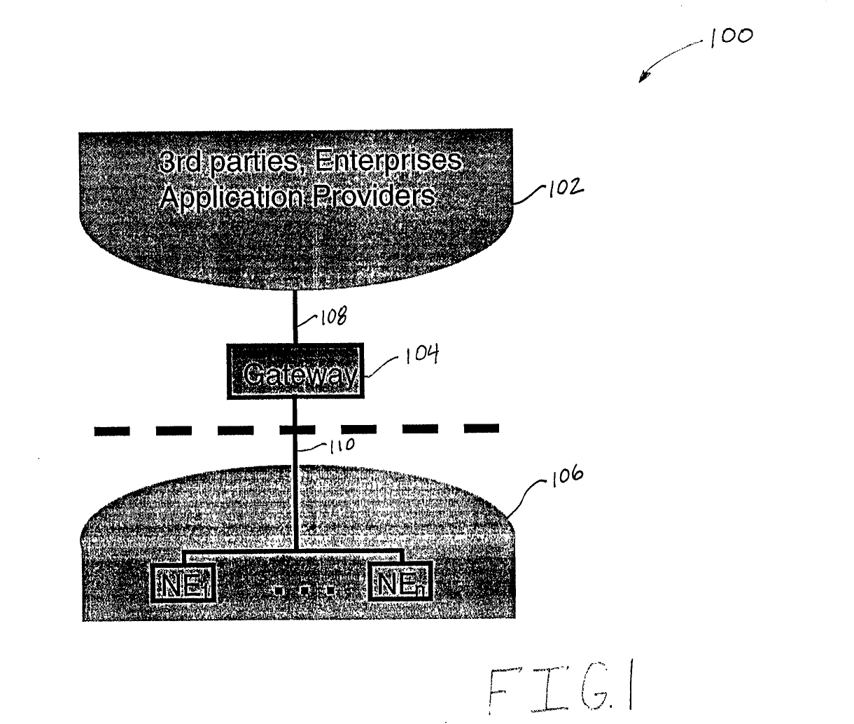

FIG. 2, previously described, illustrates a block diagram of an exemplary architecture including a logical gateway;

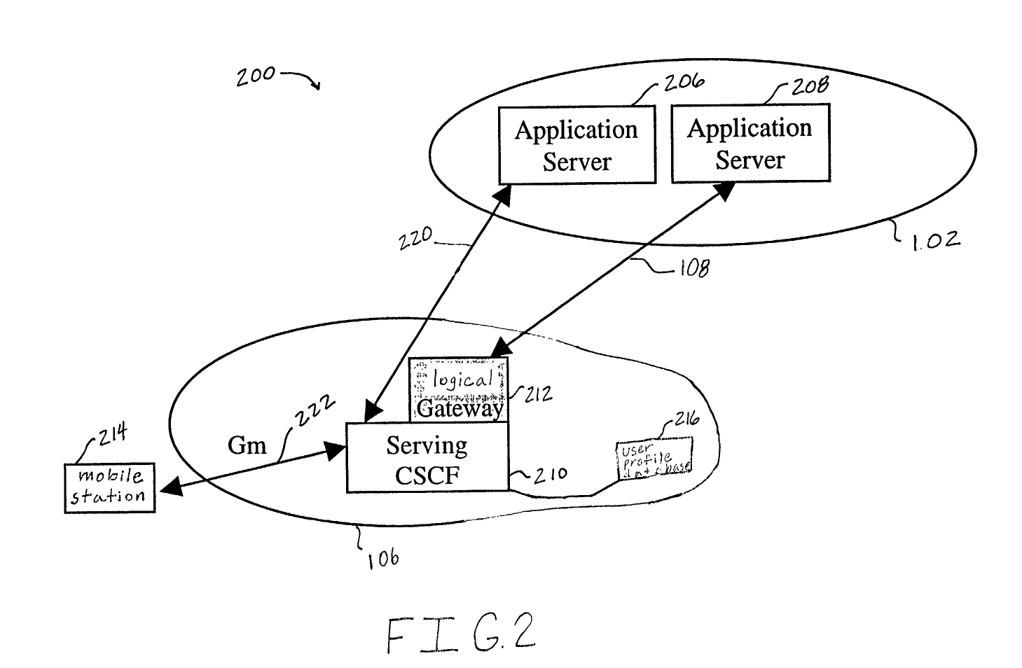

FIG. 3 illustrates a block diagram showing two levels of application-programming interfaces (APIs) in accordance with the present invention; and

FIG. 4 illustrates a block diagram of operation of external-service APIs and internal-service APIs in an exemplary application-programming interface-based architecture in accordance with the present invention.

### DESCRIPTION

In the following Description, for purposes of explanation and not limitation, specific details are set forth in order to provide a thorough understanding of the present invention. However, it will be apparent to those of ordinary skill in the art that the present invention can be practiced in other embodiments that depart from this specific details. In other instances, detailed description of well-known methods, devices, etc. are omitted so as not to obscure the description of the present invention with unnecessary detail.

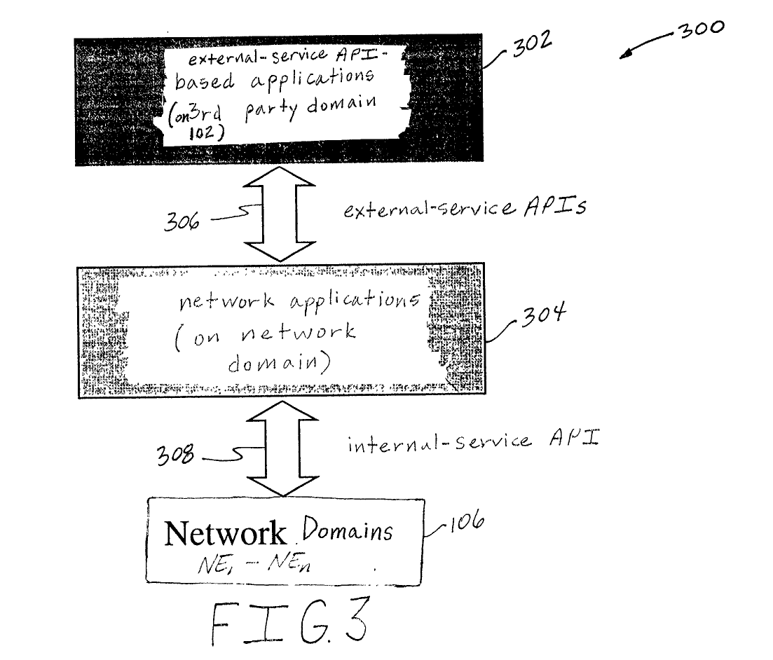

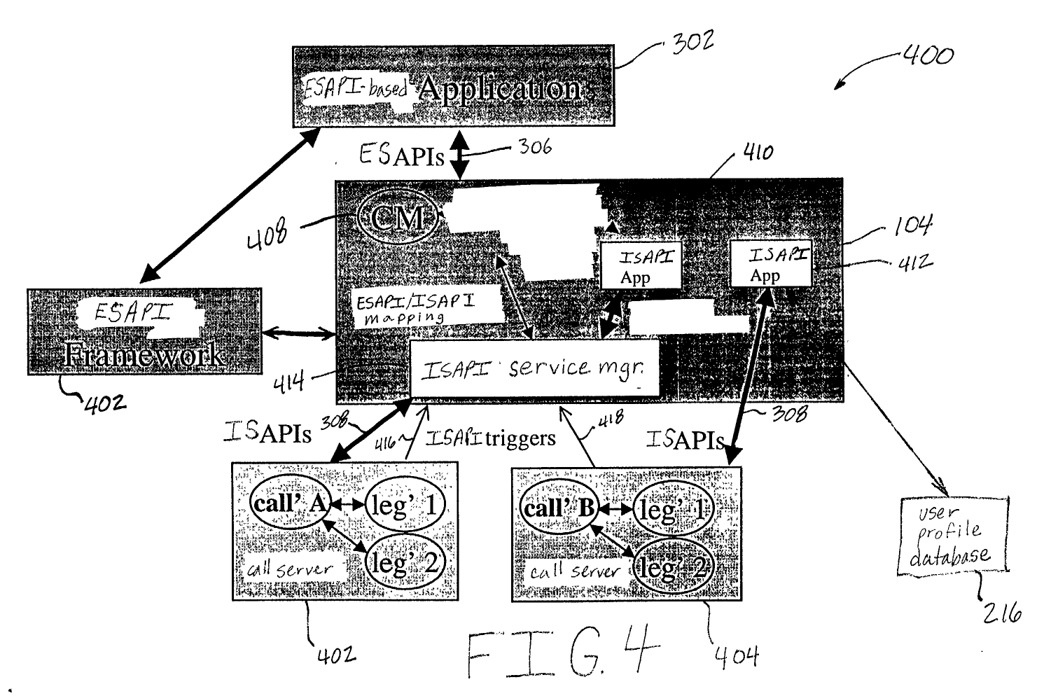

Preferred embodiments of the present invention and its advantages are best understood by referring to FIGS. 3-4 of the Drawings, like numerals being used for like and corresponding parts of the various Drawings.

Aspects of Parlay and Parlay/OSA, which are both application-programming interfaces, will be used to describe preferred embodiments of the present invention. However, it should be understood that the principles of the present invention are applicable to other application-programing-interface-based systems, especially those in which third-party-service-provider applications access telecommunication networks via one or more application-programming interfaces.

Although the Parlay/OSA APIs were developed for the officially-stated reason of being used by third-party service providers to develop services that utilize the network's capabilities, the APIs can also be used directly by the network operators themselves. APIs can, in accordance with the teachings of the present invention, be used by both network operators (and virtual network operators) and also by third-party service providers that have little or no telecommunications knowledge. It is therefore preferable that APIs to be used by third-party service providers be very high-level and abstract, so that the third-party service providers are not required to understand intimate details of the telecommunications network but are still able to access telecommunication network capabilities with their applications.

It is also advantageous to be able to control access to network capabilities and to have strong security mechanisms so that third-party service providers do not do damage to the telecommunications network and do not subject users of the network to any operations that are undesirable in the view of the network operator. Security issues are of prime importance because APIs to be used by third-party service providers operate at a border between different business' domains. In contrast, APIs to be used solely by network operators do not imply these security issues because they operate only within the particular network operator's domain. Therefore, it is preferable that the APIs used solely by the network operators not use security features of the Parlay and OSA frameworks.

In contrast, APIs to be used by the network operators are preferably more low-level, less abstract, and do not have the restrictions or security mechanisms of the APIs to be used by third-party service providers, since the network operators presumably have the knowledge and expertise to prevent undesirable operations on the network from occurring. Therefore, the objectives of third-party service providers and of network operators with respect to use of API are in some respects at cross-purposes.

It is not a free choice whether application-programming interfaces (APIs) are supported by a logical gateway co-located with a network entity or whether it is supported by a physical gateway that communicates with the network. The choice whether to implement a logical gateway or a physical gateway depends in part on how the APIs are defined. If the APIs are too abstract and are designed to communicate, for example, with ten network entities, then a logical gateway cannot be used. If the APIs are supported by a logical gateway co-located with a single network entity and the network entity with which the logical gateway is co-located needs to communicate with the other nine network entities, then the architecture becomes one that by necessity includes a physical gateway. A physical gateway necessarily implies a need for an intermediate API or protocol for communication between the gateway and the network entities. Therefore, the APIs should be defined in order to maximize the advantages and minimize the drawbacks of each of the types of gateways.

Reference is now made to FIG. 3, wherein there is shown a block diagram illustrating two levels of application-programming interfaces in accordance with the present invention. An architecture 300 includes external service API-based applications 302 located on the third-party domain 102, network applications 304 on the network domains 106, and the network domains 106 including the network entities NE₁-NEₙ. The external service API-based applications 302 communicate with the network applications 304 via external service APIs 306, while the network applications 304 communicate with the network entities NE₁-NEₙ via internal service APIs 308.

The external service APIs 306 are primarily for third party service providers. Therefore, the external service APIs 306 are more abstract than the internal service APIs 308, which means that third-party service provider developers of applications need not be bothered with details of the network domains 106. Because the external service APIs 306 are more abstract than the internal service APIs 308, the external service APIs 306 allow the external service API-based applications 302 to speak to a plurality of the network entities NE₁-NEₙ. It is therefore likely that the external service APIs 306 will need to be supported by a physical gateway such as the gateway 104. In a preferred embodiment of the present invention, the external-service APIs 306 in effect abstracts an entire network, such that the external-service APIs 306 can be mapped onto the internal-service APIs in order to access capabilities of one or more of the network entities NE₁-NEₙ. Moreover, the external-service APIs 306 can preferably be used by third-party service providers to access network-operator-provided services. These network-operator-provided services can in turn use the internal-service APIs 308 to access capabilities of the network entities NE₁-NEₙ.

The internal service APIs 308 are targeted towards network operators and are thus preferably designed as an interface to a single network entity, such as one of the network entities NE₁-NEₙ. Therefore, the internal service APIs 308 do not provide the level of abstraction that is provided in the external service APIs 306. In addition, the internal service APIs 308 preferably provide more power to the network operator to provide lower-level, more network-technology-specific (e.g., SIP-based call control), services. Therefore, the internal service APIs 308 are preferably supported by a logical gateway co-located with a network entity, such as the gateway 212. In light of the above, it is preferable that each network entity with which an external service API-based application will communicate be adapted to support the internal service APIs 308.

Use of a physical gateway such as the gateway 104 to support the external service APIs 306 provides better security for the network operator and also provides a physical firewall between the network operator and the third-party domain 102. In addition, the physical gateway 104 can serve as a buffer between the network operator and the third-party domain that can be closed when necessary, such as, for example, in an overload situation. In contrast, a logical gateway is more efficient for supporting the internal service APIs 308, primarily because the need for intermediate APIs or protocols, such as on the interface 110, is avoided. The internal service APIs 308 and the external service APIs 306 can share components and also can be two versions of the same application programming interface. In a preferred embodiment, the external-service API operates according to Parlay and the internal-service API operates according to OSA.

Thus, it can be seen from FIG. 3 that use of external service APIs and internal service APIs solves many of the problems associated with logical gateways and physical gateways. The external service APIs are preferably supported on a physical gateway, which provides the benefits of a physical gateway without any of its drawbacks. The internal service APIs are preferably supported on a logical gateway co-located with a network entity, which provides the benefits of a logical gateway while eliminating the drawbacks of logical gateways.

Reference is now made to FIG. 4, wherein there is shown a block diagram illustrating operation of external-service APIs and internal-service APIs in an exemplary application-programming interface-based architecture in accordance with the present invention. The architecture 400 includes the external service API-based applications (ESAPI) 302 located in the third-party domain 102, the physical gateway 104, an external service API framework 402, a call server 404, a call server 406, a call manager 408, an internal-service API (ISAPI) application 410, and internal service API application 412, and an internal service API service manager 414. The call manager 408, the internal-service API application 410, the internal-service API application 412, and the internal-service API service manager 414 are resident on the physical gateway 104. Also included in the architecture 400 is the user profile database 216.

The physical gateway 104 communicates with the external service API-based applications 302 via the external service APIs 306. The internal service API applications 410 and 412 communicate with the call servers 402 and 404 via the internal-service APIs 308. Each of the call server 402 and call server 404 support the internal-service APIs 308 directly such that there is in effect a logical gateway such as the gateway 212 between the internal service API applications 410 and 412 and the call servers 402 and 404.

The internal-service API application 410 is shown communicating via the internal service APIs 308 with the internal service API manager 414. The internal service API service manager 414 is shown communicating with the call server 402 via the internal-service APIs 308 and also via internal-service API triggers 416 and 418 from the call server 402 and the call server 402, respectively. Operation of the internal service API service manager 414 and the use of the internal service API triggers 416 and 418 is described in more detail in the co-pending United States Patent Application entitled “Application-Programming-Interface-Based Method and Apparatus Including Triggers” filed concurrently with this application and bearing Attorney Docket No. 27950-432USPT. It will be understood by those of ordinary skill in the art that the present invention can be practiced with or without the use of the internal service API triggers 416 and 418 and/or the internal service API service manager 414.

Parlay and OSA registration procedures imply the existence of a physical gateway. That is, as a result of registration, a registering application obtains a reference to a manager object (e.g., a call manager), which will be the point of access for the application to a network capability (e.g., call control) during the lifetime of the application (i.e., until the application is withdrawn). The point of access of the application to the network capability is static, is likely to be unique, and must be located somewhere. If the application originates from a third-party service provider, and is therefore an external-service API 306, this location is in the physical gateway 104.

However, if the application is an internal-service application, such as, for example, the ISAPI application 412, when a particular subscriber registers to a network, the network operator prefers to have a choice of which call server will serve calls relative to the subscriber. This selection by the network operator may be based on various criteria, such as, for example, network load or geographical/topological proximity to the subscriber (e.g., whether the user is located in Europe or North America). Each time the subscriber registers with the network (e.g., turns on the subscriber's mobile telephone), there could potentially be a different call server associated to the subscriber. The ability of the network operator to select which call server will serve calls relative to the subscriber is even more critical when the subscriber is able to register with the call server from a network operator other than the subscriber's home network operator (i.e., visited-network control of sessions).

Consequently, it is preferable for internal-service APIs that a subscriber not be statically associated with a particular call server. The number and identity of call servers to which a subscriber can be associated is not necessarily known a priori.

Therefore, in a preferred embodiment of the present invention, the registration procedures of Parlay and OSA are not used for internal-service APIs. Rather, trigger information is stored in a database, such as, for example, the user-profile database 216, and is accessible by a call server, such as, for example, the call servers 402 and 404. The trigger information permits the call servers to be able to access applications via the service manager 414. In contrast, in this preferred embodiment, applications are not able to specify particular call servers via the service manager 414. Instead, the service manager 414 makes these determinations itself. Use of triggers in connection with application-programming interfaces is discussed in more detail in the co-pending U.S. Patent Application entitled APPLICATION-PROGRAMMING-INTERFACE-BASED METHOD AND SYSTEM INCLUDING TRIGGERS.

Exemplary operation of the external service API-based applications 302 on the architecture 400 will now be described. First, the applications 302 interact with the external service API framework 402. This interaction includes making initial contact with the framework 402, the applications 302 authenticating themselves with the framework 402, the framework 402 authenticating itself to the external service API-based applications 302, the applications 302 discovering what services and external service application programming interfaces 306 are supported by the network 106, and subscription of the applications 302 to one or more of those services as desired.

Next, as a result of the subscription by the external service API applications 302, the framework 402 communicates with the gateway 104 and retrieves a reference of one or more objects in the gateway 104, which could be, for example, of the call manager (CM) 408. Next, the gateway 104 creates a call manager object and provides a reference to the call manager object to the framework 402. Next, the framework 402 provides this reference to the applications 302. From this point forward, the applications 302 can interact directly with the gateway 104. The applications 302 interact with the gateway 104 using the reference to the call manager 408. The call manager 408 is the primary point of contact between the applications 302 and the gateway 104. The applications 302 speak to the call manager 408 via the external service APIs 306.

The call manager 408 interacts with either the internal service API applications 410 or 412 or the internal service API service manager 414 in order to invoke internal service API applications that map to the external service API applications 302. The gateway 104 performs this mapping function so that capabilities sought by the external service API applications 302 can be accessed.

Next, the internal service API applications 410 and 412 communicate with the call servers 402 or 404 or the ISAPI service manager 414 as needed via the internal service APIs. If service interaction management is needed, internal service applications, such as, for example, the internal service API application 410, communicate with the internal service API service manager 414. The internal service API service manager 414 acts as a proxy between the internal service API application 410 and, for example, the call server 402. The internal service API service manager 414 serving as a proxy permits the internal service API service manager 414 to perform service interaction management functions, such as, for example, when two internal service API applications are executed near to one another in time and a decision needs to be made about in what manner they will be executed.

An example of a situation in which service interaction management might be necessary is when the output of a first internal service API application is the input of a second internal service API application. Another example is when execution of a first internal service API application dictates that a second internal service API application not be executed.

The internal service API applications 410 and 412 can also speak to other network entities besides the call servers 410 and 412, such as, for example, the user profile database 216. It is preferable that the internal service API applications 410 and 412 be permitted to speak to network entities directly without going through the internal service API service manager 414 only if there are no service interaction management issues. The determination that there are no service interaction management issues would typically be made by the internal service API service manager 414, which would then inform the application that it is permitted to communicate directly with a given network entity such as the call server 404 or the user profile database 216.

The call servers 402 and 404 and the user profile database 216 can be part of a home or visited network. In a preferred embodiment, the internal service APIs 308 are OSA APIs, the external service APIs 306 are Parlay APIs, the ISAPI applications 410 and 412 are compatible with OSA, and the external service API-based applications 302 and external service API framework 402 are compatible with Parlay. However, it will be appreciated by those of ordinary skill in the art that the present invention can be implemented in other application programming interface-based systems.

In a preferred embodiment, the external-service APIs 306 are a subset of the internal service APIs 308. Because many third-party service providers who develop external service API-based applications 302 are not as knowledgeable about the details of telecommunications networks as are network operators, the external service APIs 306 should preferably be simpler to use and offer a higher level of abstraction, more restricted functionality, and higher security features than the internal service APIs 308.

Although the external service APIs 306 are preferably targeted towards third-party service providers, there may be situations in which a network operator would want to use the external service APIs 306 as well as the internal service APIs 308. For example, an external service API would probably not include an API that provides topological network information (e.g., which mobile switching center is handling a given user and which cell user is located in). In contrast, this information is highly relevant to a network operator and would most likely be included in an internal service API. In addition, many network operators would want to provide additional security against damage to their network by third-party applications, while, in contrast, they would want full access to their own networks, since they themselves would be responsible for any damage caused by their own applications.

One of the advantages of the present invention is that an application is not bound to a specific call server or other network entity. Rather, the network can freely select which call server or other network entity is going to handle a given user. This is possible because of the logical gateway approach utilized with the internal service APIs. For example, the internal service API service manager 414 could direct an application to an object on a particular call server in a home network, or, in the alternative, the internal service API service manager could direct the application to a network entity in another, visited, network.

Although preferred embodiments of the methods, systems, and arrangements of the present invention have been illustrated in the accompanying Drawings and described in the foregoing Description, it will be understood that the present invention is not limited to the embodiments disclosed, but is capable of numerous rearrangements, modifications, and substitutions without departing from the spirit and scope of the present invention as set forth and defined by the following claims.

What is claimed is:

1. A method of providing telecommunications services comprising the steps of:
an external-service application communicating with a gateway via an external-service application-programming interface (API), wherein the external-service API is adapted to permit the external-service application to communicate with a plurality of entities of the network; and
the gateway invoking at least one internal-service application, the at least one internal-service application communicating with at least one entity of the plurality of entities via an internal-service API, wherein the internal-service API is supported directly by the at least one entity of the plurality of entities.

2. The method of claim 1 wherein the gateway operates as a physical gateway.

3. The method of claim 2 wherein the external-service API permits the external-service application to be agnostic with respect to topology of the network.

4. The method of claim 3 wherein the internal-service API obviates a need for an API or a protocol between the gateway and the at least one entity.

5. The method of claim 1 wherein the external-service API is a subset of the internal-service API.

6. The method of claim 5 wherein the external-service API is more abstract than the internal-service API.

7. The method of claim 1 wherein the at least one entity operates as a logical gateway.

8. The method of claim 1 wherein the gateway provides security against the external-service application to the network.

9. The method of claim 1 wherein the internal-service application is located on the gateway.

10. The method of claim 1 wherein the internal-service application is located on an entity of the plurality of entities.

11. The method of claim 1 wherein the internal-service API operates according to OSA.

12. The method of claim 11 wherein the external-service API operates according to Parlay.

13. A telecommunications system comprising:
a gateway adapted to communicate via an external-service application-programming interface (API) with entities external to a telecommunications network and via an internal-service API with a plurality of entities of the network; and
at least one network entity adapted to communicate with the gateway and on which is directly supported the internal-service API, wherein the direct support obviates a need for a protocol between the gateway and the at least one entity.

14. The system of claim 13 wherein the gateway comprises a physical gateway.

15. The system of claim 14 wherein the gateway is adapted to provide security against the entities external to the network.

16. The system of claim 14 wherein the external-service API permits the external-service application to be agnostic with respect to topology of the network.

17. The system of claim 13 wherein the external-service API is a subset of the internal-service API.

18. The method of claim 17 wherein the external-service API is more abstract than the internal-service API.

19. The system of claim 13 wherein the at least one entity comprises a logical gateway.

20. The system of claim 13 wherein the internal-service application is located on the gateway.

21. The system of claim 13 wherein the internal-service application is located on an entity of the plurality of entities.

22. The method of claim 13 wherein the internal-service API operates according to OSA.

23. The method of claim 22 wherein the external-service API operates according to Parlay.

24. A telecommunications gateway adapted to:
communicate via an external-service application-programming interface (API) with at least one entity external to a telecommunications network; and
communicate via an internal-service API with a plurality of entities of the network, wherein the at least one entity external to the network is agnostic with respect to topology of the network and the plurality of entities of the network directly support the internal-service API.

25. The gateway of claim 24 wherein the gateway comprises a physical gateway.

26. The gateway of claim 25 wherein the gateway is adapted to provide security against the entity external to the telecommunications network.

27. The gateway of claim 25 wherein the internal-service API obviates a need for a protocol between the gateway and the at least one entity.

28. The gateway of claim 24 wherein the external-service API is a subset of the internal-service API.

29. The method of claim 28 wherein the external-service API is more abstract than the internal-service API.

30. The gateway of claim 24 wherein the at least one entity comprises a logical gateway.

31. The gateway of claim 24 wherein the internal-service application is located on the gateway.

32. The gateway of claim 24 wherein the internal-service application is located on an entity of the plurality of entities.

33. The method of claim 24 wherein the internal-service API operates according to OSA.

34. The method of claim 33 wherein the external-service API operates according to Parlay.
